(19) United States
(12) Patent Application Publication
(10) Pub. No.: US 2022/0227289 A1
(43) Pub. Date: Jul. 21, 2022

(54) EXTERNAL NOTIFICATION SYSTEM AND EXTERNAL NOTIFICATION METHOD

(71) Applicant: TRAM, INC., Plymouth, MI (US)

(72) Inventors: Alan YEE, Plymouth, MI (US); Haruhiko HASHIMOTO, Plymouth, MI (US)

(73) Assignee: TRAM, INC., Plymouth, MI (US)

(21) Appl. No.: 17/151,676

(22) Filed: Jan. 19, 2021

(51) Int. Cl. B60Q 1/50; B62D 1/04; B60Q 1/26

(52) U.S. Cl. CPC B60Q 1/50; B60Q 1/2665; B62D 1/046

(57) ABSTRACT

An external notification system includes a first detector, a controller, and an information output device. The first detector detects when a body part of a driver is in contact with or proximate to a notification triggering portion located inside a vehicle and outputs a first detection signal. The controller generates a notification control signal based on the first detection signal. The information output device outputs external notification information based on the notification control signal over a period in which the body part is in contact with or proximate to the notification triggering portion.

### BACKGROUND

### Field

The following description relates to an external notification system and an external notification method.

### Description of Related Art

When driving a vehicle, a driver may come across a situation in which he or she is forced to stop the vehicle. One example of such a situation would be when a police officer orders the driver to stop the vehicle at a checkpoint or the like. Under such a situation, for example, when the police officer asks questions through the window while the driver is seated in the driver seat, the driver may be ordered to place both hands where they can be seen by the police officer to indicate that the driver is not taking a suspicious action. However, if the hands of the driver cannot be seen clearly by the police officer due to one reason or another such as a dark condition, the police officer may not understand what the driver is intending to do or how the driver is behaving. This may lead to a trouble that compromises the safety of the driver. Another example would be when the driver is forced to stop his or her vehicle by another driver with road rage. In this case, the safety of the driver may also be compromised after stopping the vehicle. For example, the vehicle may be hit from the rear by a following vehicle when suddenly stopping.

There is a conventional system that determines, for example, whether the hands of the driver are on the steering wheel of the vehicle and notifies the driver of the determination result (US Patent Application Publication No. US2011/0246028). Nonetheless, there is no system that ensures the safety of the driver by readily and promptly notifying the present situation of the driver to a person outside the vehicle (police officer in first situation, and driver of following vehicle in second situation).

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one aspect, an external notification system includes a first detector, a controller, and an information output device. The first detector detects when a body part of a driver is in contact with or proximate to a notification triggering portion located inside a vehicle and outputs a first detection signal. The controller generates a notification control signal based on the first detection signal. The information output device outputs external notification information based on the notification control signal over a period in which the body part is in contact with or proximate to the notification triggering portion.

In another aspect, an external notification method includes steps of detecting when a body part of a driver is in contact with or proximate to a notification triggering portion located inside a vehicle; generating a notification control signal based on the detection of contact or proximity of the body part; outputting external notification information based on the notification control signal over a period in which the body part is in contact with or proximate to the notification triggering portion; detecting when the body part is separated from the notification triggering portion; and stopping the output of the external notification information based on the detection that the body part is separated from the notification triggering portion.

Other features and aspects will be apparent from the following detailed description, the drawings, and the claims.

### BRIEF DESCRIPTION OF THE DRAWINGS

FIG. 1 is a schematic block diagram showing an exemplary external notification system in accordance with an embodiment.

FIG. 2 is a schematic block diagram showing exemplary elements of the external notification system shown in FIG. 1.

FIG. 3 is a timing diagram illustrating an exemplary external notification process in accordance with an embodiment.

FIG. 4 is a schematic diagram showing one example of a vehicle including the external notification system.

FIG. 5 is a schematic diagram showing an operational example of a grip sensor in accordance with an embodiment.

FIG. 6 is a schematic diagram showing an exemplary information output device in accordance with an embodiment.

FIG. 7 is a schematic diagram showing an exemplary arrangement pattern of multiple grip sensors.

FIG. 8 is a schematic diagram showing another exemplary arrangement pattern of the multiple grip sensors.

FIG. 9A is a graph illustrating an exemplary grip determination process that uses a threshold value.

FIG. 9B is a schematic diagram showing a grip state in which four fingers are separated from a steering wheel.

FIG. 9C is a schematic diagram showing a grip state in which one finger is separated from the steering wheel.

FIG. 9D is a schematic diagram showing a complete grip state in which all fingers are gripping the steering wheel.

FIG. 10 is a graph illustrating another exemplary grip determination process.

FIG. 11 is a flowchart illustrating an exemplary external notification method in accordance with an embodiment.

FIG. 12 is a flowchart illustrating an exemplary external notification process that includes a driver status record process.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

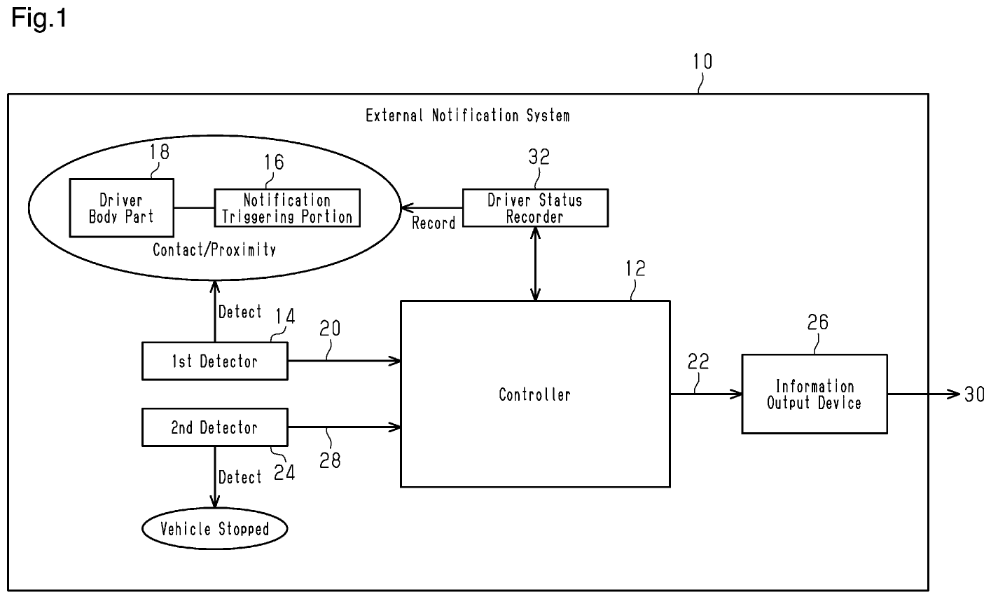

FIG. 1 is a schematic block diagram showing an exemplary external notification system 10 in accordance with an embodiment.

The external notification system 10 includes a controller 12 and a first detector 14. The controller 12 controls processing performed by the entire external notification system 10 in a centralized manner. The first detector 14 is connected to the controller 12. When the first detector 14 detects that a body part 18 of a driver is in contact with or in the proximity of a notification triggering portion 16, which is located inside a vehicle 1 (refer to FIGS. 4 and 5), the first detector outputs a first detection signal 20 to the controller 12.

In the present disclosure, the term “notification triggering portion” refers to a specified position inside the vehicle designated as a position that starts an external notification process performed by the external notification system 10, which will be described later. The notification triggering portion 16 may be designated to any member, component, or part of member or component of the vehicle 1.

In one example, a steering wheel of the vehicle 1 is designated as the notification triggering portion 16. However, the notification triggering portion 16 is not limited to the steering wheel and may be, for example, part of a dashboard located frontward from the steering wheel. Alternatively, in correspondence with the application to which the functionality of the external notification system 10 is applied, an armrest of the driver seat, an assist grip that can be held by the driver, or any other portion near the driver seat may be designated as the notification triggering portion 16. Hereafter, the notification triggering portion 16 may be referred to as the steering wheel 16 to facilitate understanding.

The body part 18 of the driver may be any part of the body that can take an action for contacting the notification triggering portion 16. In one example, the first detector 14 detects a hand of the driver as the body part 18 that is in contact with or in the proximity of the notification triggering portion 16. However, the body part 18 is not limited to a hand and may be a finger, an elbow, or a foot of the driver in correspondence with the application to which the functionality of the external notification system 10 is applied. Hereafter, the body part 18 may be referred to as the hand 18 to facilitate understanding.

In the present disclosure, the phrase “in contact with” refers to a state in which the body part 18 is in direct contact with the notification triggering portion 16, and the phrase “in the proximity of” refers to a state in which the body part 18 is in indirect contact, or non-contact, with the notification triggering portion 16. The first detector 14 detects when the body part is in contact with, in the proximity of, or both of in contact with and in the proximity of the notification triggering portion 16.

In one example, the first detector 14 detects when the hand 18 of the driver is in contact with or in the proximity of the steering wheel 16 and outputs the first detection signal 20. The controller 12 generates (makes active) a notification control signal 22 based on the first detection signal 20.

The external notification system 10 further includes a second detector 24 and an information output device 26 that are connected to the controller 12. The second detector 24 detects when the vehicle 1 has stopped and outputs a second detection signal 28 to the controller 12. The information output device 26 outputs external notification information 30 based on the notification control signal 22 over a period in which the body part 18 is in contact with or in the proximity of the notification triggering portion 16.

In FIG. 1, the external notification system 10 includes the second detector 24. However, the external notification system 10 does not necessarily have to include the second detector 24 as long as the controller 12 receives a signal indicating that the vehicle 1 has stopped.

In some embodiments, the controller 12 generates the notification control signal 22 based on the first detection signal 20 and the second detection signal 28. In this manner, the information output device 26 outputs the external notification information 30 over a period in which the vehicle 1 is stopped and the body part 18 is in contact with or in the proximity of the notification triggering portion 16.

In the present disclosure, the term “external notification information” refers to information issued from the vehicle 1 to the outside of the vehicle 1 and includes any information that is transmitted through a display, sound, or a combination of a display and sound. The display may be continuous lighting, intermittent lighting, presentation of an image or a video, or a combination of the above.

The information output device 26 may be any existing device or dedicated device that can issue the external notification information 30 from the vehicle 1. The information output device 26 outputs the external notification information 30 over a period in which the first detector 14 detects contact or proximity of the body part 18. Thus, when the external notification information 30 is output from the vehicle 1 (information output device 26), the vehicle 1 is stopped and the body part 18 is in contact with or in the proximity of the notification triggering portion 16.

If necessary, the external notification system 10 may further include a driver status recorder 32 that is connected to the controller 12. The driver status recorder 32 records the driver status while the body part 18 is in contact with or in the proximity of the notification triggering portion 16.

In some embodiments, the driver status may be shown by a video of the body part 18 that is in contact with or in the proximity of the notification triggering portion 16. The driver status is shown by, for example, a video of the driver holding the steering wheel 16 with the hand 18. In addition to or instead of the above video, the driver status may be shown by a video of the entire driver seat or the entire vehicle interior including the driver. In addition to or instead of the above video, the driver status may be shown by a video of the person (e.g., police officer or another involved person) to whom the driver is speaking through the window from the driver seat. In addition to or instead of the above video, the driver status may be shown by a video of unspecified persons or other vehicles near the vehicle 1.

In some embodiments, the controller 12 activates the driver status recorder 32 at a time point at which the first detection signal 20 has been output over a predetermined duration. In the example shown in FIG. 1, the controller 12 activates the driver status recorder 32 at a time point at which the first detection signal 20 has been output over a predetermined duration while the second detection signal 28 is output. Therefore, the recording of the driver status begins at a time point at which the hand 18 of the driver has been in contact with or in the proximity of the steering wheel 16 over the predetermined duration while the vehicle 1 is stopped.

In some embodiments, the controller 12 continues recording with the driver status recorder 32 even after the output of the first detection signal 20 (detection of body part 18 being in contact with or in proximity of notification triggering portion 16) is stopped until a specified recording stopping condition is satisfied. In the example shown in FIG. 1, the controller 12 stops the driver status recorder 32 at a time point at which the output of the second detection signal 28 is stopped. Therefore, the recording of the driver status is stopped, for example, when the driver starts moving the vehicle 1.

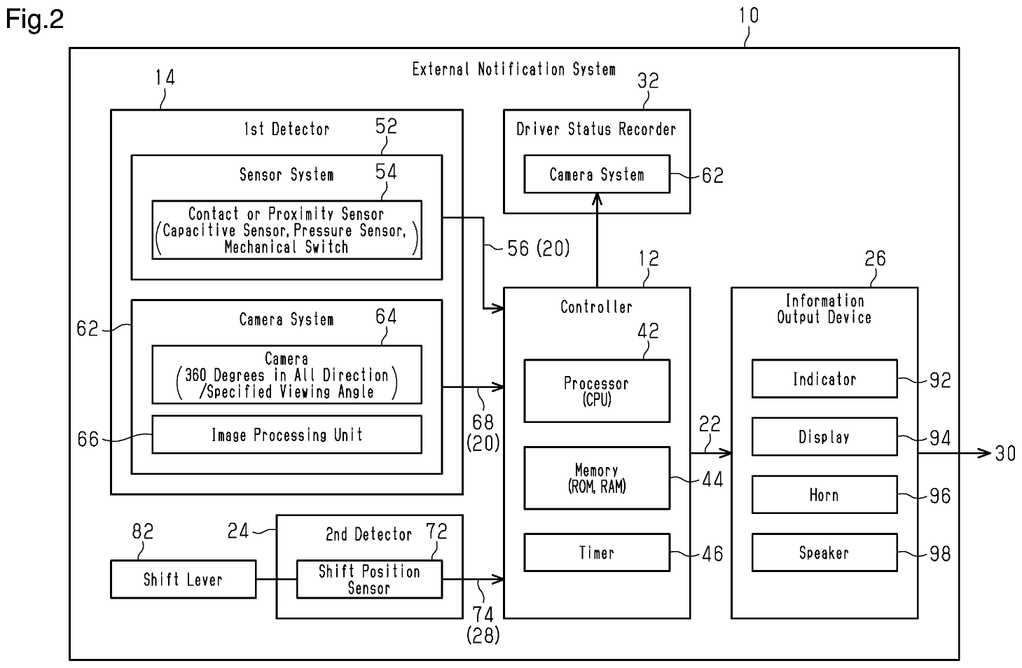

FIG. 2 is a schematic block diagram showing exemplary elements of the external notification system 10 shown in FIG. 1.

The controller 12 includes one or more processors 42 and a memory 44. The memory 44 stores commands (computer programs) that can be executed by the processor 42 to perform an external notification process. The processor 42 may include a central processing unit (CPU). In addition to or instead of the CPU, the processor 42 may include a graphic processing unit (GPU), exclusive hardware such as an application specific integrated circuit (ASIC), or a combination of the above. The memory 44 includes any medium such as a random-access memory (RAM), a read-only memory (ROM), an optical storage device, a magnetic storage device, or a flash memory that is accessible by a computer (processor 42).

The controller 12 further includes a timer 46. The controller 12 uses the timer 46 to measure the time elapsed from a time point at which the first detector 14 starts to output the first detection signal 20. Then, the controller 12 determines whether the first detection signal 20 has been output for the predetermined duration, that is, whether the body part 18 has been in contact with or been in the proximity of the notification triggering portion 16 over the predetermined duration.

The first detector 14 includes a sensor system 52. The sensor system 52 includes one or more contact or proximity sensors 54 that detect when the body part 18 is in contact with or in the proximity of the notification triggering portion 16 and output a sensor signal 56 (first detection signal 20).

Each of the contact or proximity sensors 54 includes, for example, at least one of a capacitive sensor, a pressure sensor, and a mechanical switch. The capacitive sensor measures changes in capacitance to detect when the body part 18 is in contact with or in the proximity of the notification triggering portion 16. The pressure sensor measures pressure changes to detect when the body part 18 is in contact with the notification triggering portion 16. The mechanical switch includes a mechanical component (e.g., push-button) that is operable by the driver and arranged on the notification triggering portion 16. The mechanical switch detects when the body part 18 is in contact with the notification triggering portion 16 in response to an operation by the driver.

As shown in FIGS. 4, 5, and 7, in some embodiments, the one or more contact or proximity sensors 54 are arranged inside the steering wheel 16 as grip sensors each including a capacitive sensor. Hereafter, the contact or proximity sensors 54 may be referred to as the grip sensors 54.

The steering wheel 16 is substantially annular, and the grip sensors 54 include a first grip sensor 54A and a second grip sensor 54B. The first grip sensor 54A is disposed in a first region of the steering wheel 16, and the second grip sensor 54B is disposed in a second region of the steering wheel 16. The first region may occupy approximately one-half of the steering wheel 16 in the circumferential direction, and the second region may occupy the remaining approximately one-half of the steering wheel 16 in the circumferential direction. As shown in FIGS. 5 and 7, the first grip sensor 54A detects when the steering wheel 16 is being held by a right hand 18A and outputs a first sensor signal 56A (first detection signal 20). In the same manner, the second grip sensor 54B detects when the steering wheel 16 is being held by a left hand 18B and outputs a second sensor signal 56B (first detection signal 20).

As shown in FIG. 2, the first detector 14 may include a camera system 62, if necessary. In some embodiments, the camera system 62 includes a camera 64 and an image processing unit 66. The image processing unit 66 may be incorporated in the camera 64. The camera 64 generates image data of a driver seat region including the notification triggering portion 16. The image processing unit 66 obtains image data from the camera 64 and detects when the body part 18 is in contact with or in the proximity of the notification triggering portion 16 from the image data. Based on the detection, the camera system 62 outputs a detection signal 68 (first detection signal 20). The camera 64 may be, for example, an omnidirectional camera that captures images over 360 degrees in all directions, a camera that captures images at a specified viewing angle, or any image capturing device. As shown in FIG. 4, the camera 64 may be, for example, mounted on the dashboard of the vehicle 1.

In FIG. 2, the first detector 14 includes both the sensor system 52 and the camera system 62. However, the first detector 14 may include only one of the sensor system 52 or the camera system 62.

In some embodiments, the second detector 24 includes a shift position sensor 72 that detects the position of a shift lever 82. When the shift position sensor 72 detects that the shift lever 82 is in a parking position, the shift position sensor 72 outputs a detection signal 74 (second detection signal 28). The second detector 24 may include a vehicle speed sensor instead of the shift position sensor 72.

The information output device 26 includes an indicator 92, a display 94, a horn 96, a speaker 98, or any combination of the indicator 92, the display 94, the horn 96, and the speaker 98.

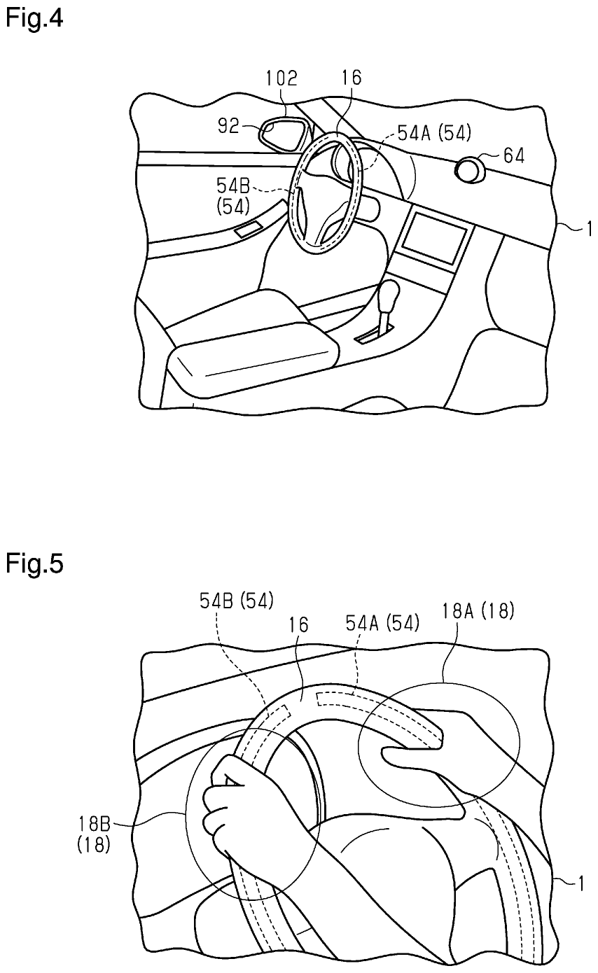

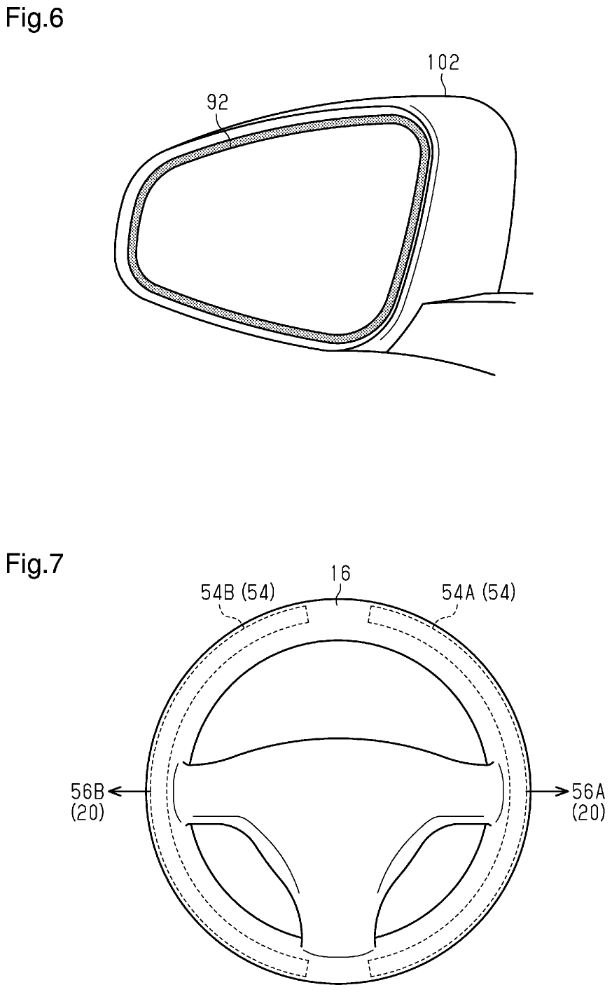

For example, the indicator 92 includes turn signals, a hazard warning signal, other vehicle lights, a dedicated indicator, or any combination of the above signals and lights. As shown in FIGS. 4 and 6, an example of the dedicated indicator may be the indicator 92 arranged along the periphery of a side mirror 102 and configured to be illuminated continuously or intermittently.

The display 94 may use, for example, at least part of the windshield or the rear window as a screen. Alternatively, the display 94 may be an image display that is employed in the side mirror 102. Any display device may be used as the display 94 as long as the display shows images or videos that can be seen from outside the vehicle 1.

The driver status recorder 32 includes the camera system 62. For example, the camera system 62 may be shared by the driver status recorder 32 and a first detector 14. In other words, the first detector 14 may use the camera system 62 of the driver status recorder 32 to detect when the body part 18 is in contact with or in the proximity of the notification triggering portion 16.

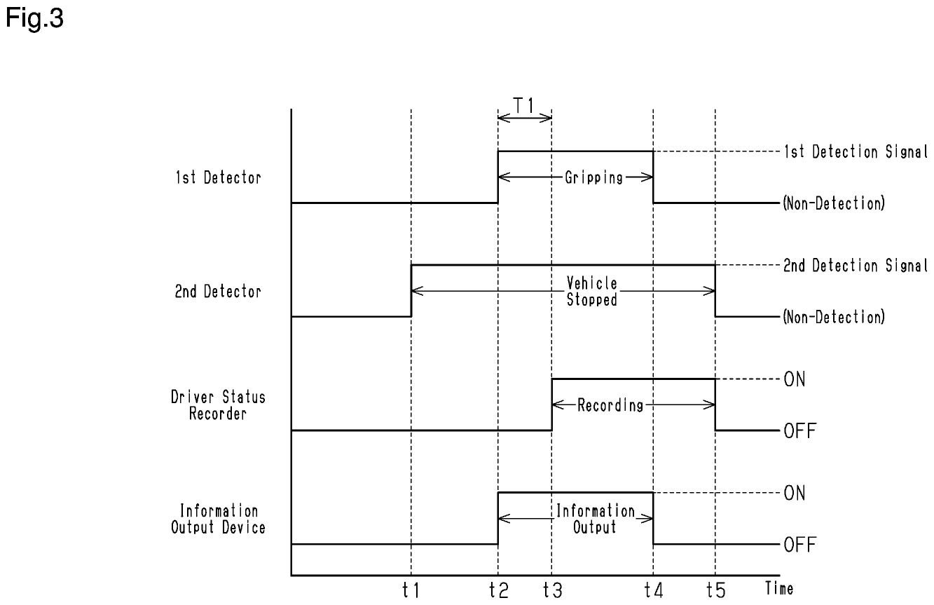

An exemplary external notification process in accordance with an embodiment will now be described with reference to FIGS. 1 to 3. FIG. 3 is a timing diagram illustrating the exemplary external notification process.

At time t1, the second detector 24 detects that the vehicle 1 has stopped and outputs the second detection signal 28. For example, the shift position sensor 72 detects that the shift lever 82 is in the parking position.

At time t2, the first detector 14 detects that the body part 18 of the driver is in contact with or in the proximity of the notification triggering portion 16 and outputs the first detection signal 20. For example, the grip sensors 54 (54A and 54B) detect that the steering wheel 16 is being held by both hands 18 (18A and 18B) of the driver (refer to FIG. 5).

The controller 12 generates (makes active) the notification control signal 22 based on the first detection signal 20 and the second detection signal 28. Further, the controller 12 uses the timer 46 to measure the time elapsed from time t2 when the first detector 14 starts to output the first detection signal 20. The information output device 26 outputs the external notification information 30 based on the notification control signal 22 from the controller 12. For example, the indicator 92 of the side mirror 102 is illuminated continuously or intermittently (refer to FIG. 6).

At time t3, the controller 12 determines that the first detection signal 20 has been output over duration T1 and activates the driver status recorder 32. In the present example, the recording of the driver status is started at time t3 when the two hands 18 (18A and 18B) of the driver have been in contact with or in the proximity of the steering wheel 16 over duration T1 while the vehicle 1 is stopped.

At time t4, the first detector 14 detects that the body part 18 of the driver is separated from the notification triggering portion 16 and stops the output of the first detection signal 20. In the present example, the grip sensors 54 (54A and 54B) detect when the two hands 18 (18A and 18B) of the driver are separated from the steering wheel 16.

The controller 12 makes the notification control signal 22 inactive at time t4 when the output of the first detection signal 20 is stopped. In response, the information output device 26 stops the output of the external notification information 30. In the present example, the continuous or intermittent illumination of the indicator 92 of the side mirror 102 (refer to FIG. 6) is stopped. In this manner, the information output device 26 outputs the external notification information 30 over a period in which the notification control signal 22 is active.

At time t5, the second detector 24 detects that the vehicle 1 is starting to move and stops the output of the second detection signal 28. In the present example, the shift position sensor 72 detects that the shift lever 82 has been released from the parking position (for example, shift lever 82 shifted to drive position).

The controller 12 stops the recording of the driver status at time t5 when the output of the second detection signal 28 is stopped. The stopping of the output of the second detection signal 28 is one example of a recording stopping condition.

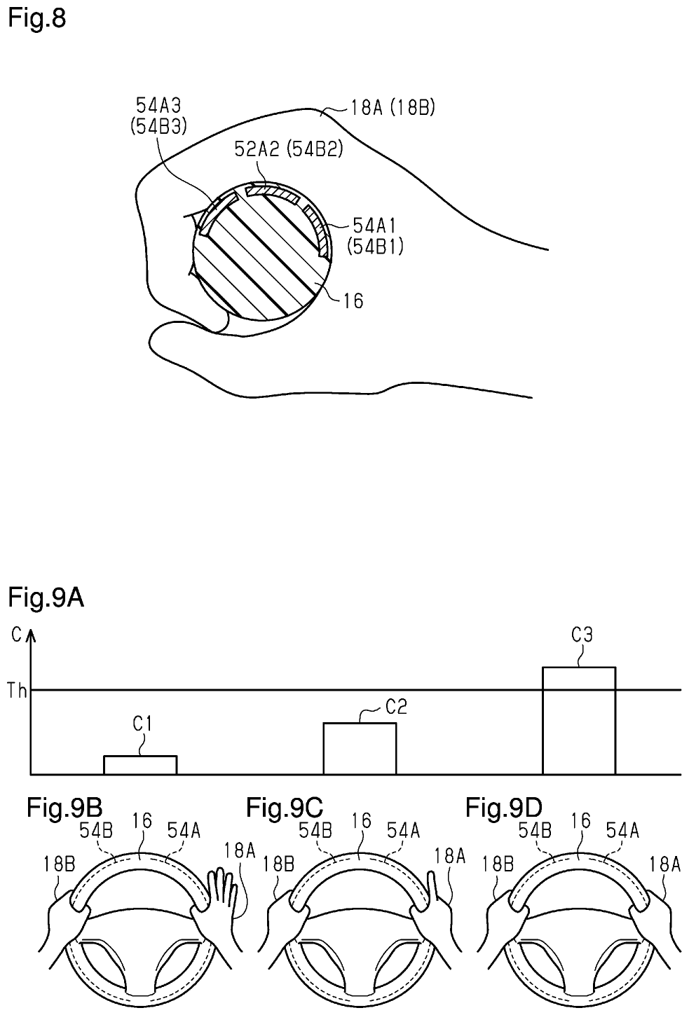

FIG. 8 is a schematic diagram showing another exemplary arrangement pattern of the grip sensors 54 (54A1, 54A2, 54A3, 54B1, 54B2, and 54B3).

As shown in FIG. 8, the grip sensors 54A1 to 54A3 are arranged in the first region of the steering wheel 16 (approximately one-half of steering wheel 16 in circumferential direction). In the same manner, as indicated in the parentheses in FIG. 8, the grip sensors 54B1 to 54B3 are arranged in the second region of the steering wheel 16 (remaining one-half of steering wheel 16 in circumferential direction). The grip sensors 54A1 to 54A3 and 54B1 to 54B3 each include a capacitive sensor in the same manner as the grip sensors 54A and 54B shown in FIG. 7.

As shown in FIG. 8, the steering wheel 16 has a circular cross section extending in a radial direction of the steering wheel 16. The grip sensors 54B1 to 54B3 are disposed in the first region of the steering wheel 16 and are adjacent to one another in the circumferential direction of the circular cross section. For example, the grip sensors 54A1 to 54A3 respectively detect when the palm of the right hand 18A, the proximal side of the fingers of the right hand 18A, and the distal side of the fingers of the right hand 18A are in contact with or in the proximity of the steering wheel 16 and output a sensor signal. In the same manner, the grip sensors 54B1 to 54B3 are disposed in the second region of the steering wheel 16 adjacent to one another in the circumferential direction of the circular cross section to respectively detect when the palm of the left hand 18B, the proximal side of the fingers of the left hand 18B, and the distal side of the fingers of the left hand 18B are in contact with or in the proximity of the steering wheel 16 and output a sensor signal.

Such an arrangement pattern allows for determination of whether the steering wheel 16 is being held by the two hands 18A and 18B. For example, when a foot or an arm of the driver is in contact with the steering wheel 16, one of the grip sensors 54A1 to 54A3 or one of the grip sensors 54B1 to 54B3 outputs a sensor signal and the rest of the grip sensors do not output sensor signals. In contrast, when the steering wheel 16 is being held by the two hands 18A and 18B, every one of the grip sensors 54A1 to 54A3 and 54B1 to 54B3 outputs a sensor signal. For example, when every one of the grip sensors 54A1 to 54A3 and 54B1 to 54B3 outputs a sensor signal, the first detector 14 outputs the first detection signal 20. This allows the first detector 14 to recognize that the body part 18, which is in contact with the steering wheel 16, is a hand.

FIG. 9A is a graph illustrating an exemplary grip determination process that uses threshold value Th. In FIG. 9A, the vertical axis indicates the capacitance of the grip sensor 54A in correspondence with three grip states of the right hand that are shown in the direction of the horizontal axis in FIGS. 9B, 9C, and 9D.

In some embodiments, when the capacitance detected by the grip sensor 54A is greater than or equal to the threshold value Th (first threshold value), the controller 12 determines that the steering wheel 16 is being held by the right hand 18A of the driver without any finger being separated from the steering wheel 16. Further, when the capacitance detected by the grip sensor 54B is greater than or equal to the threshold value Th (second threshold value), the controller 12 determines that the steering wheel 16 is being held by the left hand 18B of the driver without any finger being separated from the steering wheel 16. The first threshold value the first threshold value and the second threshold value may be the same or different.

As shown in FIG. 9B, in a grip state in which four fingers are separated from the steering wheel 16, the capacitance C1 is much lower than the threshold value Th. As shown in FIG. 9C, in a grip state in which one finger is separated from the steering wheel 16, the capacitance C2 is higher than the capacitance C1 but still lower than the threshold value Th. As shown in FIG. 9D, in a complete grip state in which all fingers are gripping the steering wheel 16, the capacitance C3 is higher than the threshold value Th. The controller 12 may compare the capacitance (sensor signal) of the grip sensor 54A with the threshold value Th to determine whether the steering wheel 16 is in the complete grip state (FIG. 9D). The same grip determination process can be applied to the grip sensor 54B.

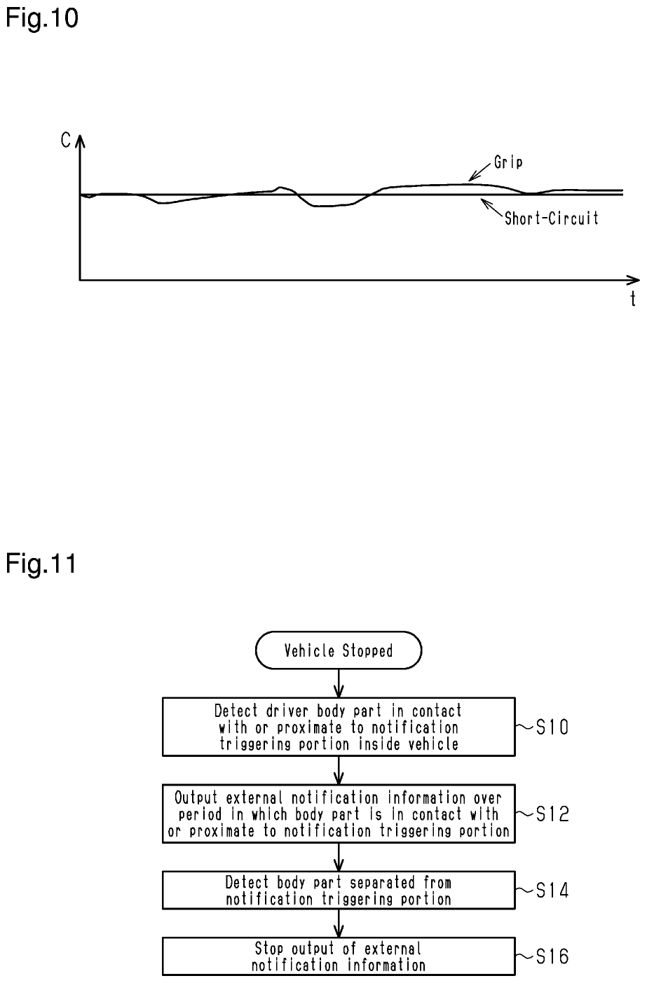

FIG. 10 is a graph illustrating another exemplary grip determination process. In FIG. 10, the horizontal axis indicates time and the vertical axis indicates the capacitance of the grip sensor 54.

For example, if a conductor is in contact with the steering wheel 16 instead of the hand 18, the capacitance (sensor signal) of the grip sensor 54 is a constant value that does not fluctuate. In contrast, when the hand 18 is in contact with the steering wheel 16, the capacitance (sensor signal) of the grip sensor 54 fluctuates finely over time. The controller 12 may determine whether the steering wheel 16 is being held by the hand 18 of the driver from such fine fluctuation of the sensor signal over time.

FIG. 11 is a flowchart illustrating an exemplary external notification method in accordance with an embodiment. The flowchart starts while the vehicle 1 is stopped.

In step S10, the first detector 14 detects that the body part 18 of the driver is in contact with or in the proximity of the notification triggering portion 16 in the vehicle 1 (timing t2 in FIG. 3). The controller 12 provides the information output device 26 with an active notification control signal 22.

In step S12, the information output device 26 outputs the external notification information 30 based on the notification control signal 22 over a period in which the body part 18 is in contact with or in the proximity of the notification triggering portion 16 (after time t2 in FIG. 3).

In step S14, the first detector 14 detects that the body part 18 is separated from the notification triggering portion 16 (timing t4 in FIG. 3). The controller 12 makes the notification control signal 22 inactive.

In step S16, the information output device 26 stops the output of the external notification information 30 in response to the inactive notification control signal 22.

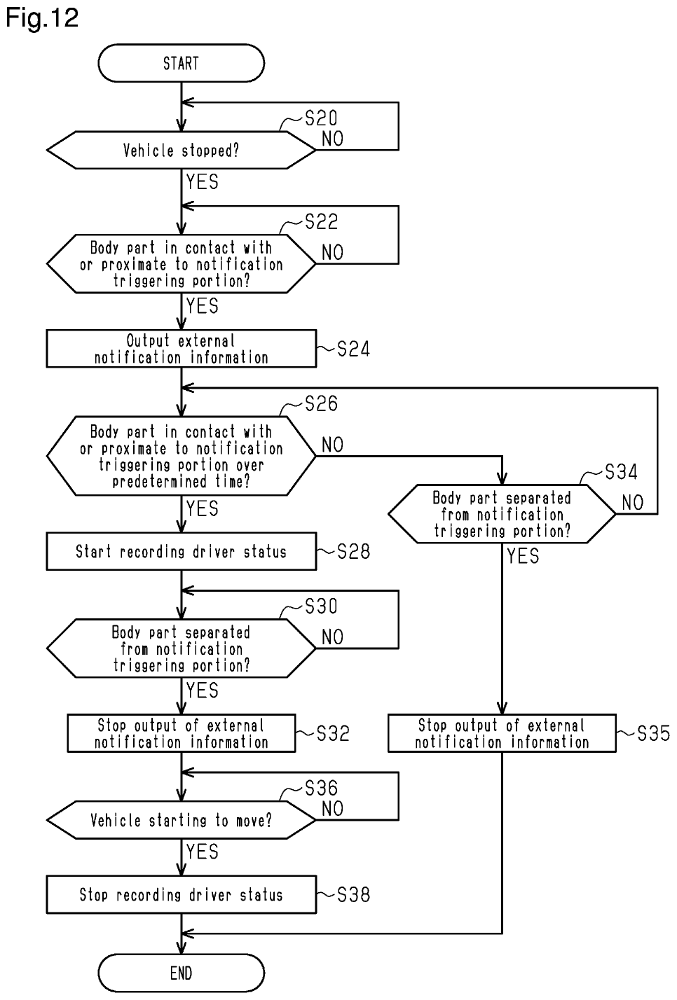

FIG. 12 is a flowchart illustrating an exemplary external notification process that includes a driver status recording process.

In step S20, the controller 12 determines whether the vehicle 1 has stopped based on the second detection signal 28 from the second detector 24. For example, the controller 12 determines that the vehicle 1 has stopped when the shift position sensor 72 detects that the shift lever 82 is in the parking position.

In step S22, the controller 12 determines whether the body part 18 is in contact with or in the proximity of the notification triggering portion 16. For example, when the grip sensor 54 detects that the steering wheel 16 is being held by the two hands 18 of the driver, the controller 12 makes the notification control signal 22 active.

In step S24, the controller 12 provides the information output device 26 with the active notification control signal 22, and the information output device 26 outputs the external notification information 30 in response to the notification control signal 22. For example, the indicator 92 of the side mirror 102 is illuminated continuously or intermittently.

In step S26, the controller 12 determines whether the body part 18 has been in contact with or in the proximity of the notification triggering portion 16 over the predetermined duration T1. When the predetermined duration T1 elapses, the controller 12 activates the driver status recorder 32 in step S28. In this manner, in the present example, the camera system 62 starts recording the driver status when the two hands 18 of the driver have been in contact with or in the proximity of the steering wheel 16 over duration T1 while the vehicle 1 is stopped.

In step S30, the controller 12 determines whether the body part 18 has been separated from the notification triggering portion 16. In the present example, when the grip sensor 54 detects that at least one of the hands 18 of the driver has been separated from the steering wheel 16, the controller 12 makes the notification control signal 22 inactive.

In step S32, the information output device 26 stops the output of the external notification information 30 in response to the inactive notification control signal 22. In the present example, the continuous or intermittent illumination of the indicator 92 of the side mirror 102 is stopped. In this manner, the information output device 26 outputs the external notification information 30 over a period in which the notification control signal 22 is active.

When a negative determination is given in step S26, the controller 12 determines in step S34 whether the body part 18 has been separated from the notification triggering portion 16 in the same manner as in step S30. When an affirmative determination is given in step S34, the controller 12 proceeds to step S35 and stops the output of the external notification information 30.

In step S36, the controller 12 determines whether the vehicle 1 is starting to move. In the present example, the controller 12 determines that the vehicle 1 is starting to move when the shift position sensor 72 detects that the shift lever 82 is in a drive position. In step S38, the controller 12 stops the driver status recorder 32. In this manner, in the present example, the camera system 62 stops recording the driver status.

The operation of the external notification system 10 in accordance with an embodiment will now be described.

In one potential situation, the driver may be ordered to stop the vehicle 1 by a police officer at a checkpoint or the like. Under such a situation, for example, when the police officer questions the driver through the window while the driver is seated in the driver seat, the police officer may ask the driver to place both hands 18 where they can be seen to indicate that the driver is not taking a suspicious action.

In this case, when the driver is holding the steering wheel 16 with both hands 18, the grip sensor 54 detects the gripping of the steering wheel 16, and the indicator 92 of the side mirror 102 is illuminated continuously or intermittently. When the police officer confirms such a continuous or intermittent illumination of the indicator 92 of the side mirror 102, the police officer will acknowledge that the driver is holding the steering wheel 16 with both hands 18. Specifically, the police officer will be notified of such a notification scheme in advance. Thus, by checking continuous or intermittent illumination of the indicator 92, the police officer can acknowledge that the steering wheel 16 is being held without the need to directly look at the driver seat. This avoids troubles that may result from interactions between the driver and a police officer.

Further, when the driver continues to hold the steering wheel 16 with both hands 18 over the predetermined duration T1, the camera system 62 is activated to start recording the driver status. The recording of the driver status continues even after the driver releases both hands 18 from the steering wheel 16 until the shift lever 82 is shifted to the drive position. Since interactions between the driver and the police officer are recorded, the driver will feel a sense of security.

In another potential situation, another driver with road rage may force the driver to stop the vehicle 1. In this case, the vehicle 1 may be hit from the rear by a following vehicle when suddenly stopping.

In such a case, when the driver holds the steering wheel 16 with both hands 18, the grip sensor 54 detects gripping of the steering wheel 16 and continuously or intermittently illuminates the hazard warning signal, which is one example of the indicator 92. The continuous or intermittent illumination of the hazard warning signal will notify the driver of a following vehicle that the vehicle 1 in front has stopped. This avoids being hit from the rear by a following vehicle and ensures the safety of the driver.

Further, when the driver continues to hold the steering wheel 16 with both hands 18 over the predetermined duration T1, the camera system 62 is activated to start recording the driver status. The recording of the driver status continues even after the driver releases both hands 18 from the steering wheel 16 until the shift lever 82 is shifted to the drive position. Since interactions between the driver and the driver with road rage are recorded, the driver will feel a sense of security.

The external notification system 10 according to an embodiment has the following advantages.

(1) The information output device 26 outputs the external notification information 30 to the outside of the vehicle 1 over a period in which the body part 18 of the driver is in contact with or in the proximity of the notification triggering portion 16. Therefore, a person outside the vehicle 1 can acknowledge the present status of the driver (body part 18 in contact with or in proximity of notification triggering portion 16 or vehicle 1 stopped) from the external notification information 30. In this manner, the driver can inform the person outside the vehicle 1 about the present status of the driver without performing complicated operations. As a result, the driver can promptly convey his or her intention when interacting with the person outside the vehicle 1.

(2) When the body part 18 of the driver is in contact with or in the proximity of the notification triggering portion 16 over the predetermined duration T1, recording of the driver status is started. In this manner, the driver status is recorded when the driver interacts with a person outside the vehicle 1. Thus, the driver will feel a sense of security. Consequently, this ensures the safety of the driver.

(3) The recording of the driver status is continued until the vehicle 1 starts moving, for example, when the shift lever 82 is shifted to the drive position. In this manner, the driver can feel a sense of security.

(4) The steering wheel 16 is designated as the notification triggering portion 16. In this case, the external notification information 30 is output when the driver simply holds the steering wheel 16 with both hands 18. Therefore, the driver does not have to perform complicated operations to output the external notification information 30.

(5) The first detector 14 includes the grip sensor 54 that detects when the steering wheel 16 is held by both hands 18 (18A and 18B) of the driver. Thus, the driver is further restricted from performing a false gripping action in which the driver holds the steering wheel 16 with one hand 18.

(6) The grip sensor 54 includes the grip sensors 54A1 to 54A3 and 54B1 to 54B3 to detect when the steering wheel 16 is completely held by the entire hand 18 including the fingers. This configuration further restricts the driver from performing a false gripping action.

(7) The grip determination process that uses the threshold value Th is performed to further restrict the driver from performing a false gripping action.

(8) Fine fluctuations over time of the sensor signal (capacitance) of the grip sensor 54 are detected to further restrict the driver performing a false gripping action.

It should be apparent to those skilled in the art that the present disclosure may be embodied in many other specific forms without departing from the spirit or scope of the invention. Particularly, it should be understood that the above embodiment may be embodied in the following forms.

(a) The first detector 14, the second detector 24, the information output device 26, and the driver status recorder 32 do not have to be configured as shown in FIG. 2.

(b) The grip sensor 54 does not have to include a capacitive sensor. Further, the arrangement pattern of the grip sensors 54 in the steering wheel 16 is not limited to that of the above embodiment. For example, a single grip sensor 54 may be used.

(c) The external notification process illustrated in FIG. 3 is an example and other control process may be employed. For example, the output of the external notification information 30 may be continued until the recording of the driver status is stopped. Alternatively, the recording of the driver status and the output of the external notification information 30 may be started simultaneously.

(d) The camera system 62 may be controlled in a modified manner. For example, the camera 64 may capture images of the outside of the vehicle 1 until gripping of the steering wheel 16 is detected, and the camera 64 may capture images of the inside of the vehicle 1 when gripping of the steering wheel 16 is detected or when the steering wheel 16 has been held over the predetermined duration T1. In this manner, the camera 64 may be controlled to switch image capturing areas.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although embodiment of the present invention has been described in detail, it should be understood that various changes, substitutions, and alterations could be made hereto without departing from the spirit and scope of the invention.

What is claimed is:

1. An external notification system, comprising:
a first detector that detects when a body part of a driver is in contact with or proximate to a notification triggering portion located inside a vehicle and outputs a first detection signal;
a controller that generates a notification control signal based on the first detection signal; and
an information output device that outputs external notification information based on the notification control signal over a period in which the body part is in contact with or proximate to the notification triggering portion.

2. The external notification system according to claim 1, wherein
the controller makes the notification control signal active at a time point at which the first detection signal is output from the first detector and makes the notification control signal inactive at a time point at which the output of the first detection signal is stopped, and
the information output device outputs the external notification information over a period in which the notification control signal is active.

3. The external notification system according to claim 1, wherein the first detector includes at least one of a capacitive sensor, a pressure sensor, and a mechanical switch that detects when the body part is in contact with or proximate to the notification triggering portion.

4. The external notification system according to claim 1, wherein
the notification triggering portion includes a steering wheel of the vehicle, and
the first detector includes one or more grip sensors that detect when the steering wheel being held by a hand of the driver.

5. The external notification system according to claim 4, wherein
the one or more grip sensors include multiple grip sensors each including a capacitive sensor, and
the controller determines whether the steering wheel is being held by both hands of the driver based on multiple sensor signals output from the multiple grip sensors.

6. The external notification system according to claim 5, wherein the controller determines from the multiple sensor signals whether the steering wheel is being held by both hands of the driver without any finger being separated from the steering wheel.

7. The external notification system according to claim 5, wherein
the multiple grip sensors include,
multiple first grip sensors disposed in a first region of the steering wheel, and
multiple second grip sensors disposed in a second region of the steering wheel, and
the controller
determines that the steering wheel is being held by the right hand of the driver without any finger being separated from the steering wheel when the sensor signal is output from every one of the multiple first grip sensors, and
determines that the steering wheel is being held by the left hand of the driver without any finger being separated from the steering wheel when the sensor signal is output from every one of the multiple second grip sensors.

8. The external notification system according to claim 7, wherein
the steering wheel is substantially circular and has a circular cross section extending in a radial direction of the steering wheel,
the multiple first grip sensors are disposed in the first region of the steering wheel adjacent to one another in a circumferential direction of the circular cross section, and
the multiple second sensor are disposed in the second region of the steering wheel adjacent to one another in the circumferential direction of the circular cross section.

9. The external notification system according to claim 5, wherein
the multiple grip sensors include,
one or more first grip sensors disposed in a first region of the steering wheel, and
one or more second grip sensors disposed in a second region of the steering wheel, and
the controller
determines that the steering wheel is being held by the right hand of the driver without any finger being separated from the steering wheel when capacitance detected by the first grip sensor is greater than or equal to a first threshold value, and
determines that the steering wheel is being held by the left hand of the driver without any finger being separated from the steering wheel when capacitance detected by the second grip sensor is greater than or equal to a second threshold value.

10. The external notification system according to claim 5, wherein the controller determines that the steering wheel is being held by each hand of the driver based on fine fluctuations of the multiple sensor signals over time.

11. The external notification system according to claim 1, wherein the first detector includes
a camera configured to generate image data of a driver seat region including the notification triggering portion, and
an image processing unit configured to detect when the body part is in contact with or proximate to the notification triggering portion from the image data.

12. The external notification system according to claim 1, further comprising:
a second detector that detects when the vehicle is stopped and outputs a second detection signal, wherein
the controller generates the notification control signal based on the first detection signal and the second detection signal, and
the information output device outputs the external notification information over a period in which the vehicle is stopped and the body part is in contact with or proximate to the notification triggering portion.

13. The external notification system according to claim 12, wherein
the second detector includes a shift position sensor that detects a position of a shift lever of the vehicle, and
the shift position sensor detects when the shift lever is in a parking position and outputs the second detection signal.

14. The external notification system according to claim 1, further comprising:
a driver status recorder that records a drive status while the body part is in contact with or proximate to the notification triggering portion,
wherein the controller activates the driver status recorder at a time point at which the first detection signal has been output over a predetermined duration.

15. The external notification system according to claim 14, wherein the controller continues recording with the driver status recorder even after the output of the first detection signal is stopped until a specified recording stopping condition is satisfied.

16. The external notification system according to claim 12, further comprising:
a driver status recorder that records a drive status while the body part is in contact with or proximate to the notification triggering portion,
wherein the controller
activates the driver status recorder at a time point at which the first detection signal has been output over a predetermined duration while the second detection signal is output, and
stops the driver status recorder at a time point at which the output of the second detection signal is stopped.

17. The external notification system according to claim 1, wherein the information output device includes an indicator configured to display continuous lighting or intermittent lighting.

18. The external notification system according to claim 17, wherein the indicator includes an indicator arranged along a periphery of a side mirror of the vehicle.

19. An external notification method, comprising:
detecting when a body part of a driver is in contact with or proximate to a notification triggering portion located inside a vehicle;
generating a notification control signal based on the detection of contact or proximity of the body part;
outputting external notification information based on the notification control signal over a period in which the body part is in contact with or proximate to the notification triggering portion;
detecting when the body part is separated from the notification triggering portion; and
stopping the output of the external notification information based on the detection that the body part is separated from the notification triggering portion.

20. The external notification method according to claim 19, further comprising:
detecting when the body part has been in contact with or proximate to the notification triggering portion over a predetermined duration; and
recording a driver status over a period in which the body part is in contact with or proximate to the notification triggering portion when the predetermined duration elapses.
